(19) United States
(12) Patent Application Publication
(10) Pub. No.: US 2006/0182834 A1
(43) Pub. Date: Aug. 17, 2006

(54) Extrusion calibrator cleaning apparatus and method

(76) Inventor: Duane Norman Baldwin JR., Auburn, WA (US)

Correspondence Address: Mikron Industries, Inc.,;ATTN David Gadd, 1034 Sixth Avenue North, Kent, WA, 98032, US

(21) Appl. No.: 11/243,446

(22) Filed: Oct. 4, 2005

Related U.S. Application Data
(60) Provisional application No. 60/616,197, filed on Oct. 4, 2004.

(51) Int. Cl. B29B 11/06

(52) U.S. Cl. 425/225

(57) ABSTRACT

The invention includes a calibrator washer apparatus and a method for cleaning extrusion calibrators such as a calibrator used in the extrusion of a hollow, thin walled polyvinyl profile for use in the fenestration industry. The inventive calibrator cleaning method involves scrubbing the interior calibration surface of the calibrator with a bristle brush, pumping a hot water and detergent cleaning fluid through the calibrator vacuum ports that connect to the vacuum slots in the interior calibration surface, pumping hot water through calibrator vacuum ports that connect to the vacuum slots in the interior calibration surface to rinse off the detergent. The method may further include running cool water through the calibrator vacuum ports to cool the calibrator and wiping down the cleaned calibrator with a water-displacing lubricant. The inventive calibrator washer includes a cleaning fluid tank containing a cleaning fluid, a rinse fluid tank containing a rinse fluid, a main washer tank which is consecutively supplied with and contains the wash fluid and then is supplied with and contains the rinse fluid, at least one main pump that consecutively pumps the cleaning fluid and then the rinse fluid from the main washer tank through a calibrator and back into main washer tank, and a transfer pump to consecutively empty the main washer tank of the cleaning fluid and return the cleaning fluid to the cleaning fluid tank and to empty the main washer tank of the rinse fluid and return it to the rinse fluid tank.

### PRIORITY

This application claims the benefit of the filing date of co-pending U.S. Provisional Application No.: 60/616,197, filed Oct. 4, 2004.

### TECHNICAL FIELD

The invention concerns a machine for cleaning calibrators for thin walled plastic extrusions allowing the cleaning of such a calibrator without full disassembly of the calibrator.

### BACKGROUND OF THE INVENTION

In order to manufacture thin-walled plastic extrusions and foamed extrusions, various basic components are required including an extruder, a die, a calibrator, cooling tank, puller and a saw as is well understood by persons of ordinary skill in the art. The calibrators are designed to keep the hollow, thin-walled extrusion from collapsing and to allow a foamed extrusion to properly expand and further to size an extrusion to its final desired dimensions. In order to keep the exterior walls of the extrusion against the interior walls of the calibrator, the calibrator typically include numerous vacuum slots at various places along the length of the interior walls of the calibrator where the vacuum slots are connected to a vacuum port which is further connected to a vacuum pump. Thus, the vacuum acting against the extrusion acts to keep it against the interior walls of the calibrator allowing it to cool at the desired shape and dimensions.

As one would expect, such a use of calibrators would cause the extrusion to come in contact with the walls of the calibrator which would allow build up of residue upon the interior walls of the calibrator. In addition, the vacuum on the vacuum slots causes various residues, typically melted waxes, additives or extrusion process aids, to build-up within the vacuum slots and within the passageways that connect the vacuum slots to the vacuum port. As even small amounts of residue on the interior surface of the calibrator cause changes in the shape and surface finish of the extrudate, it is necessary to periodically clean the calibrator.

The prior art method for cleaning the calibrator requires the complete disassembly of the calibrator. The calibrator is made up of a plurality of plates allowing precise vacuum slots and other features to be manufactured by machining notches in the face of an individual plate. When the plates are bolted together, the notches in one or more of the faces together form a vacuum slot. While this method dramatically simplifies the manufacture of a calibrator, it requires that the individual plates be precisely aligned and that each plate precisely mate with its neighbors to form the proper shape. Thus, the full disassembly and reassembly of the plates of the calibrator for regular periodic cleaning consumes substantial amounts of time, and introduces a significant risk of improper alignment of the plates within the calibrator that would cause the calibrator to work improperly when next used in production of an extrusion.

### SUMMARY OF THE INVENTION

It is an object of the invention to provide for a method and equipment for the cleaning of extrusion calibrators without full disassembly of the calibrator plates. The inventive machine and method of cleaning a calibrator allows a calibrator to be cleaned without disassembling the plates.

The inventive calibrator cleaning method involves scrubbing the interior calibration surface of the calibrator with a bristle brush, pumping a hot water and detergent cleaning fluid through the calibrator vacuum ports that connect to the vacuum slots in the interior calibration surface, pumping hot water through calibrator vacuum ports that connect to the vacuum slots in the interior calibration surface to rinse off the detergent. The method may further include running cool water through the calibrator vacuum ports to cool the calibrator and wiping down the cleaned calibrator with a water-displacing lubricant.

The inventive calibrator washer includes a cleaning fluid tank containing a cleaning fluid, a rinse fluid tank containing a rinse fluid, a main washer tank which is consecutively supplied with and contains the wash fluid and then is supplied with and contains the rinse fluid, at least one main pump that consecutively pumps the cleaning fluid and then the rinse fluid from the main washer tank through a calibrator and back into main washer tank, and a transfer pump to consecutively empty the main washer tank of the cleaning fluid and return the cleaning fluid to the cleaning fluid tank and to empty the main washer tank of the rinse fluid and return it to the rinse fluid tank.

### BRIEF DESCRIPTION OF THE DRAWINGS

FIG. 1 is an isometric view of a novel calibrator washing machine for use in the inventive process showing calibrators on in-feed and out-feed tables and transfer carts.

FIG. 2 is a cutaway view of a main washer tank assembly of the novel calibrator washing machine.

FIG. 3 is a cutaway view of the main washer tank assembly of the novel calibrator washing machine with a calibrator attached to and in position to be washed by the novel calibrator washing machine.

FIG. 4 is a plan view of the back of the novel calibrator washing machine with the safety covers removed.

FIG. 5 is a plan view of the front of the novel calibrator washing machine with the safety covers removed.

FIG. 6 is a plan view of the left side of the novel calibrator washing machine with the safety covers removed.

FIG. 7 is a plan view of the right side of the novel calibrator washing machine with the safety covers removed.

### DETAILED DESCRIPTION OF THE PREFERRED EMBODIMENTS

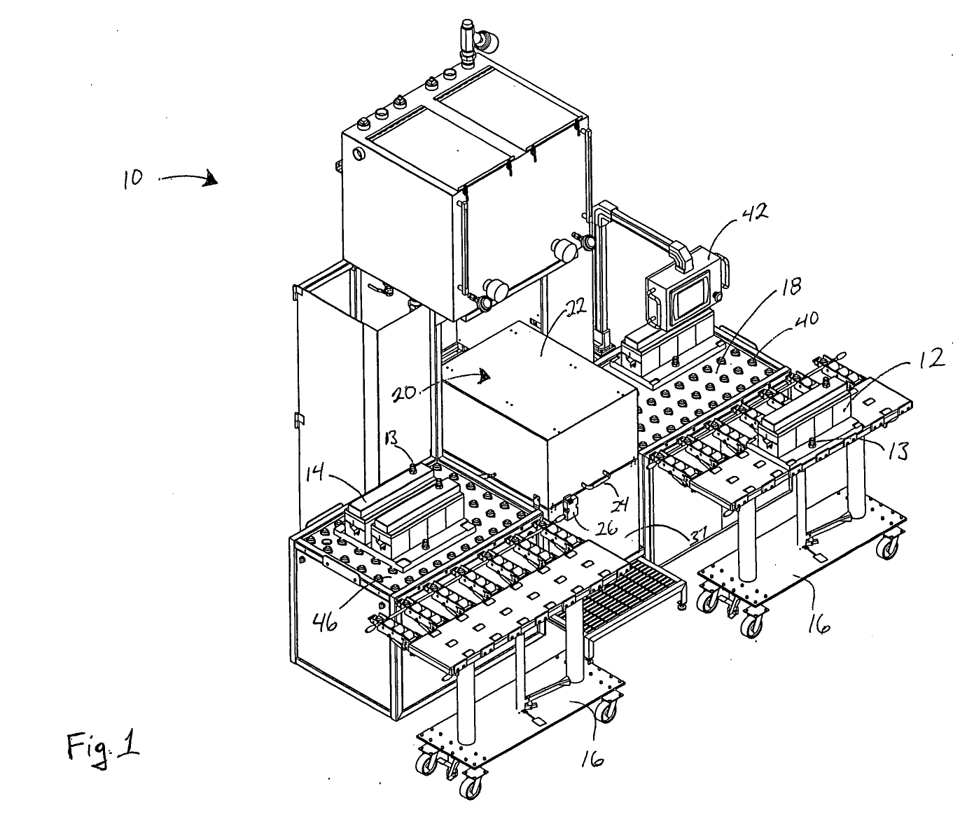

Disclosed in the drawings is a preferred embodiment of a calibrator washing machine, referred to generally with numeral 10, which allows cleaning without disassembly of the plates of plastic extrusion calibrators. The disclosed calibrator washing machine (or washer) 10 will be further detailed below, but the general manner of its use and operation will be here described with reference to FIG. 1. Prior to using washer 10, an operator would first scrub the interior calibration surface of the calibrator 12, 14, for example with a nylon long handled brush. The calibration surface is a unique shape that determines the final shape of the extrudate produced on an extrusion line as is well understood by a person of ordinary skill in the art and may be a single tool as in the calibrator designated at numeral 12 or it may be a dual tool such as the calibrator referenced at numeral 14 where two profiles are produced on an extrusion line. Calibrators 12, 14 typically have lower and upper vacuum ports 13. The operator of washer 10 would load the calibrator 12, 14 from cart 16 or from a crane (not shown) onto in-feed table 18. The calibrator 12, 14 is then moved from the in-feed table 18 into the main washer tank assembly 20. The main washer tank assembly 20 is covered by hood 22 and is lifted by the operator with handle 24 when the lock 26 is disengaged by the controller for the washer 10.

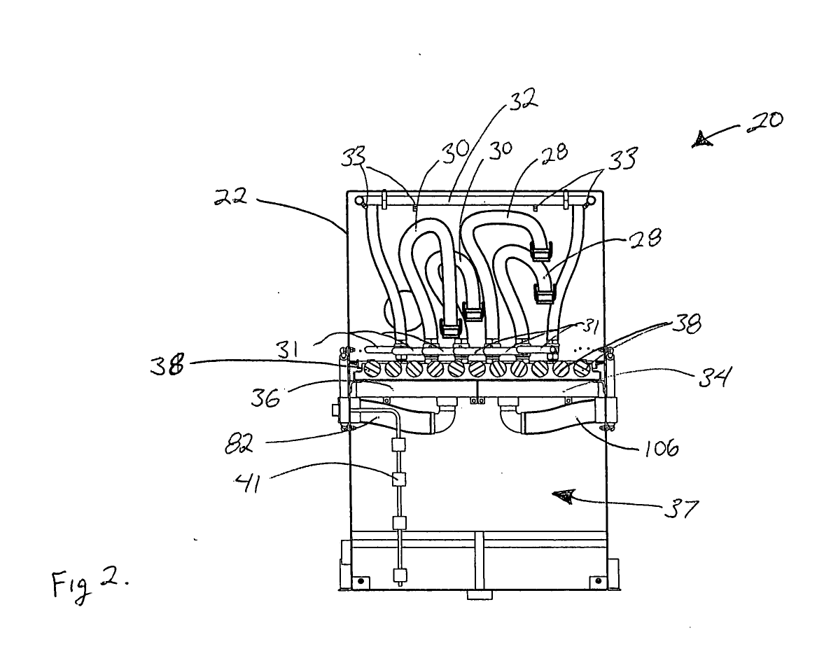

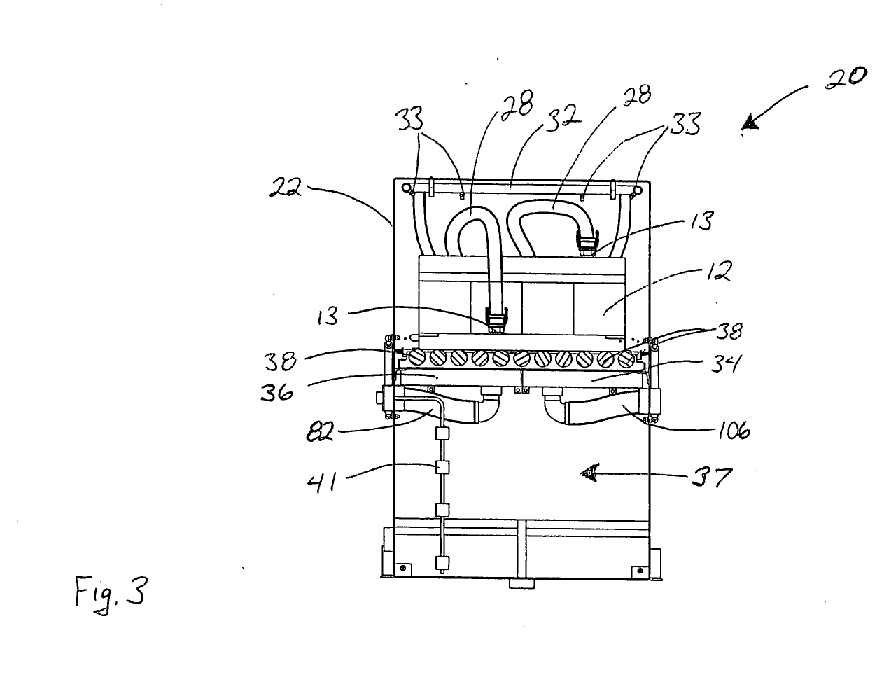

The interior of the main washer tank assembly 20 underneath hood 22 can be seen in cutaway form in FIGS. 2 and 3. As can be seen in FIGS. 2 and 3, the operator would attach either right manifold hoses 28 or left manifold hoses 30 to vacuum ports 13 of the calibrator as will be further discussed below and would open a ball valve 31 for each hose 28, 30 that is connected to a vacuum port 13 understanding that the ball valves 31 regulate the flow of fluid to each hose 28, 30. The operator would also open a ball valve 31 connected to an exterior spray line 32 that includes supplies nozzles 33 which will spray the exterior of the calibrator 12, 14. Right manifold hoses 28 are operatively connected to a right manifold 34 and left manifold hoses 30 are operatively connected to a left manifold 36 where the right manifold 34 and left manifold 36 are connected to two separate pumps allowing efficient cleaning of a dual calibrator 14, a single calibrator 12, or two single calibrators 12 as will be fully described herein below. The fluid pumped through the calibrator 12, 14 is collected in main washer tank 37. It should be noted that the calibrator 12, 14 is easily moved on the in-feed table on omni-directional rollers 40 (FIG. 1) and in the main washer tank assembly on bi-directional rollers 38 that allow the calibrator 12, 14 to move towards or away from the in-feed table 18. Float gauge 41 measures the fluid level in the main washer tank 37.

The operator inputs to the controller 42 whether a (a) a single calibrator 12 or (b) a dual calibrator 14 or two single calibrators 12 is (are) to be cleaned. If a single calibrator is to be cleaned, the operator would have connected the left manifold hoses 30 to the vacuum ports 13 of calibrator 12. If a dual calibrator 14 or two single calibrators is (are) to be cleaned, the operator would connect both the left manifold hoses 30 and the right manifold hoses 28 to the vacuum ports 13 of calibrator 14. The operator then closes hood 22 with handle 24 and the controller 42 initiates lock 26 and starts the cleaning cycle. As will be fully explained below, the washer 10 first pumps heated cleaning fluid comprised of water and detergent into the vacuum ports 13 and out the vacuum slots of the calibrator 12, 14 while the nozzles 33 spray the exterior of the calibrator 12, 14. The washer 10 then does likewise with heated rinse water and upon completion of the rinse, turns on a fan for a set period of time (not shown) to evacuate the steam from the hood 22. After the steam is evacuated, the controller 42 releases lock 26 allowing hood 22 to be opened by the operator. Operator would then move the calibrator 12, 14 to the out-feed table 46. After the calibrator 12, 14 has cooled either by passage of time or by active cooling with cool water, the operator would dry it with compressed air and then lightly coat it with a water-displacing oil such as WD-40 to prevent rust formation.

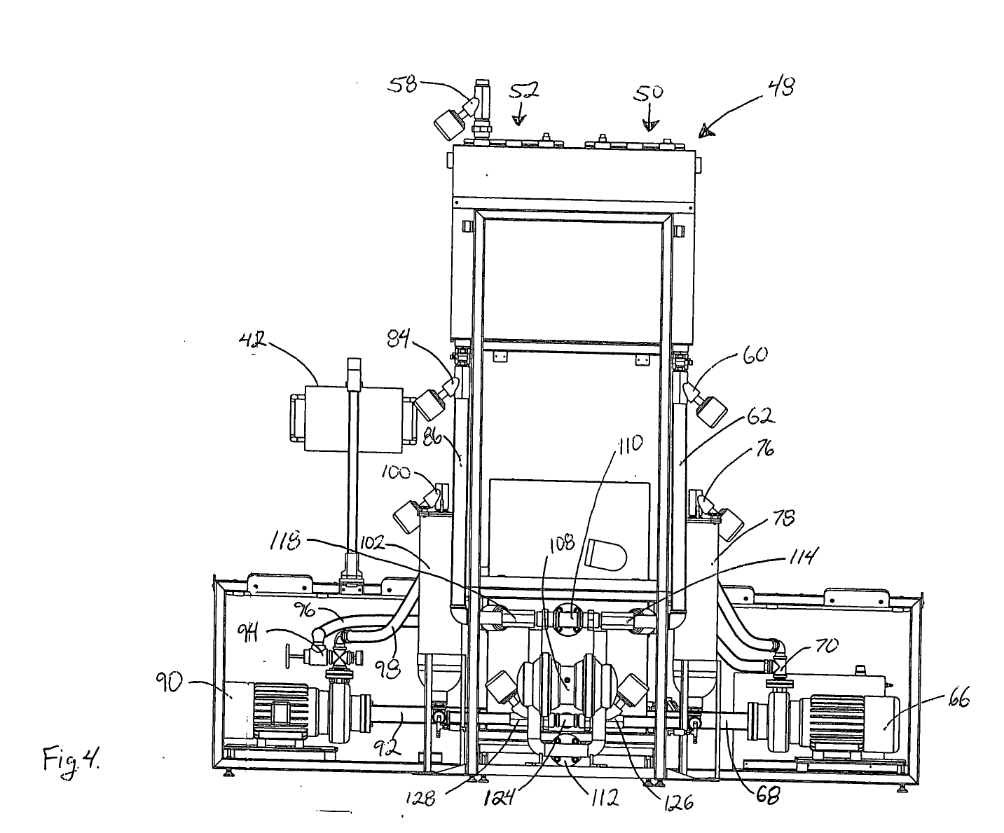

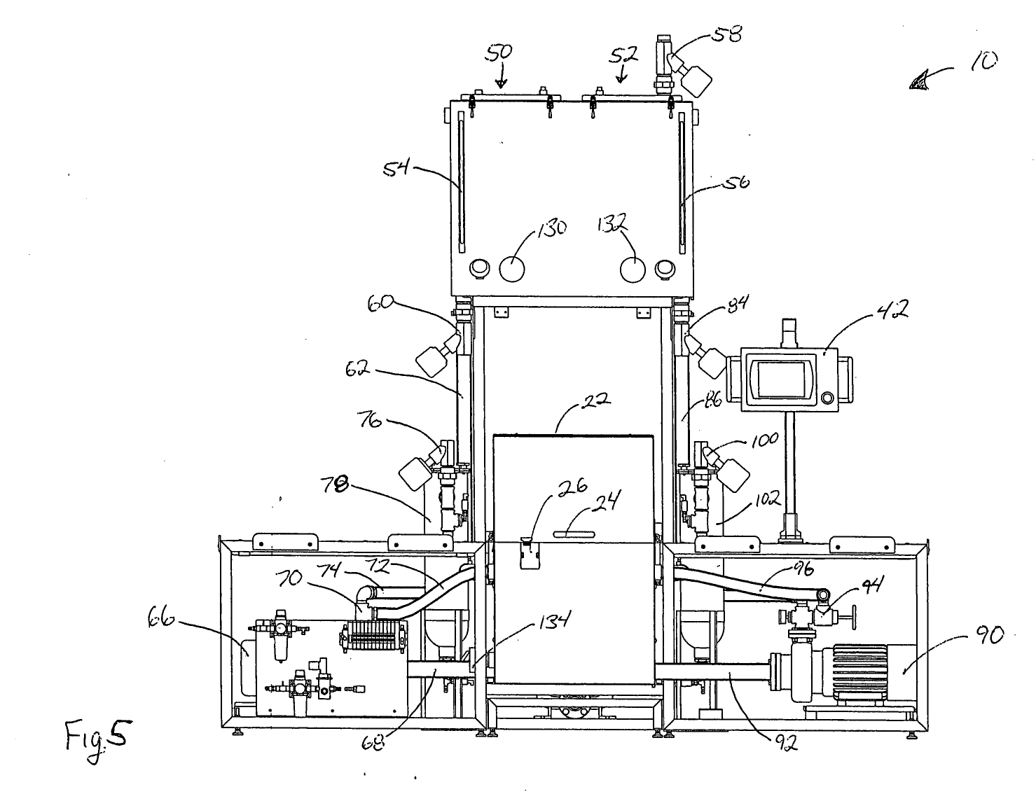

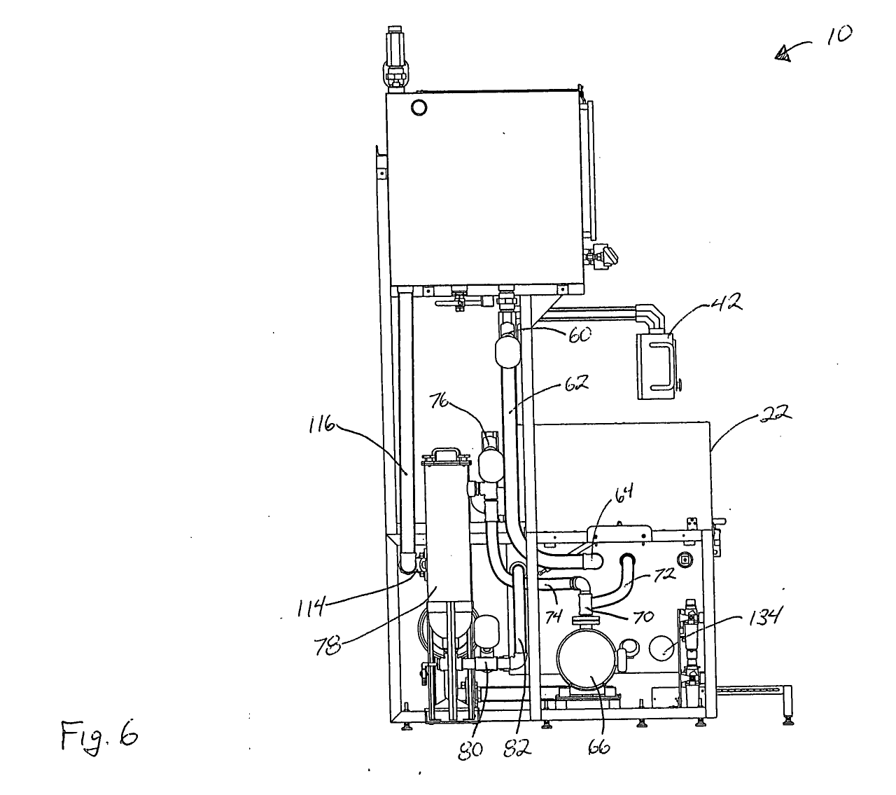

Referring now to FIGS. 4, 5 and 6, washer 10 includes an upper tank assembly 48 that includes a cleaning fluid tank 50 on the left (when viewed from the front) and on the right a rinse fluid tank 52 having, respectively, a cleaning fluid level gauge 54 and a rinse fluid level gauge 56. Rinse water supply piston valve 58 is opened by controller 42 when the level of rinse water in the rinse water tank drops below a predetermined level on rinse fluid level gauge 56. An overflow pipe and vent (not shown) exits the top of the upper tank assembly to prevent pressure or vacuum in the upper tank assembly 48 when either the cleaning fluid or rinse fluid is moved in or out of their respective tanks. Cleaning fluid drop piston valve 60 is operatively connected to the bottom of cleaning fluid tank 50 at one end and further connects to a cleaning fluid drop pipe 62 which drains into the washer fluid input port 64 which flows into the main washer tank 37 as can be best seen in FIG. 6.

As best seen in FIGS. 4, 5 and 6, left main pump 66 draws fluid from the main washer tank 37 through left pump input line 68. Left main pump 66 is a 15 horsepower water pump which is supplied with 3-phase, 480 VAC power. Left main pump 66 outputs to a pressure relief piston valve 70 which will open and allow flow through relief line 72 back to main washer tank 37 should excess pressure build and restrict flow through pump 66. In normal operation, the relief piston valve 70 remains closed and the flow from pump 66 goes to filter supply line 74 and then past left filter vacuum relief piston valve 76 which remains closed when pump 66 is operating forcing the fluid to flow into left fluid filter 78. From vacuum relief piston valve 76, flow continues through left fluid filter 78 which filters particles of significant size from the fluid. Fluid flows from the inlet at the top to the bottom of left fluid filter 78 which outputs to filter output tee 80 which is connected to one end of left manifold input line 82 which connects at its other end to the left manifold 36 which can be seen in FIGS. 2 and 3 and was described above.

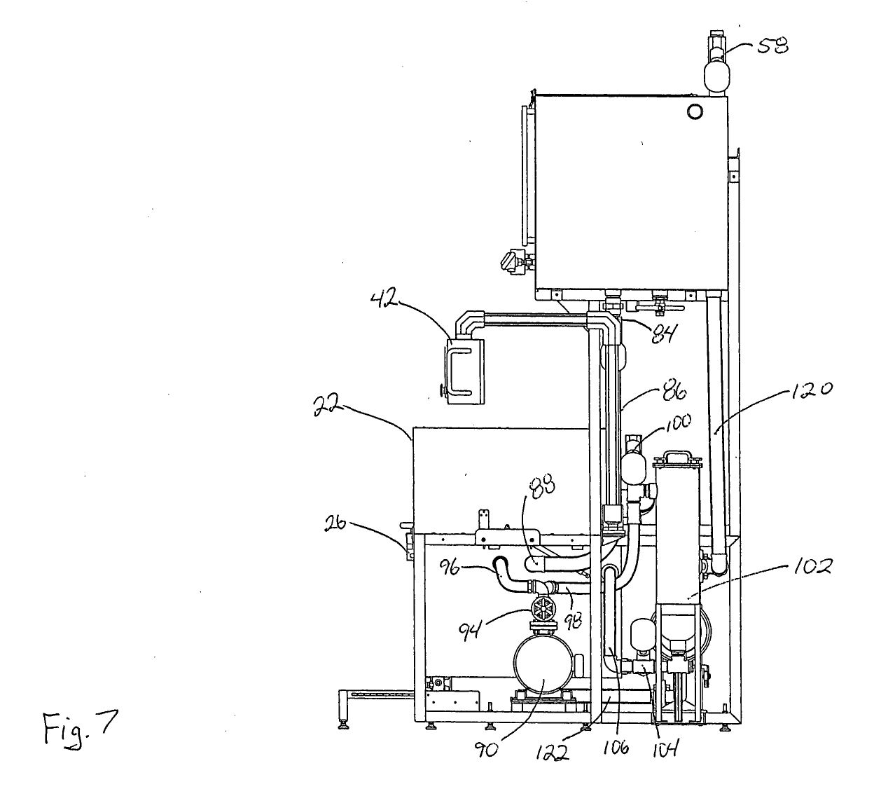

Referring now to FIGS. 4, 5 and 7, as described above, washer 10 upper tank assembly 48 included a rinse fluid tank 52, and a vent in the upper tank assembly 48 to prevent pressure or vacuum in the upper tank assembly when either the cleaning fluid or rinse fluid is moved in or out of their respective tanks. Additionally, rinse fluid drop piston valve 84 is operatively connected to the bottom of rinse fluid tank 52 at one end and further connects to a rinse fluid drop pipe 86 which drains into the washer fluid input port 64 which flows into the main washer tank 37 as can be best seen in FIG. 7.

As best seen in FIGS. 4 and 7, in a similar manner to the left main pump 66 and associated equipment, a right main pump 90 draws fluid from the main washer tank 37 through right pump input line 92. Right main pump 90 is also a 15 horsepower water pump supplied with 3-phase, 480 VAC power. Right main pump 90 outputs to an over-pressure relief piston valve 94 which will open and allow flow through relief line 96 back to main washer tank 37 should excess pressure build and restrict flow through pump 90. In normal operation, the over-pressure relief piston valve 94 remains closed and the flow from pump 90 goes to filter supply line 98 and then to right filter vacuum relief piston valve 100 which remains closed when pump 90 is operating forcing the fluid to flow into right fluid filter 102. From vacuum relief piston valve 100, flow continues through right fluid filter 102 which filters particles of significant size from the fluid. Fluid flows from the inlet at the top to the bottom of right fluid filter 102 which outputs to filter output tee 104 which is connected to one end of right manifold input line 106 which connects at its other end to the right manifold 38 which can be seen in FIGS. 2 and 3 and was described above.

With reference to FIGS. 4, 6 and 7, transfer pump 108 pumps fluid to the upper transfer pump junction 110 from the lower transfer pump junction 112. Upper junction 110 is connected to both a cleaning fluid return piston valve 114 and a rinse fluid return valve 118. The cleaning fluid return piston valve 114 is further connected to cleaning fluid return line 116 which allows flow into the cleaning fluid tank 50 as can best be seen in FIG. 6. Upper junction 110 also connects to rinse fluid return piston valve 118 which is further connected to rinse fluid return line 120 that allows flow into the rinse fluid tank 52 as can be seen in FIG. 7. Lower transfer pump junction 112 connects transfer pump 108 to drain line 122 allows flow from the bottom of main washer tank 37. A filter drain tee 124 is attached to the back wall of the main washer tank 37 and allows flow into main washer tank 37 from a left filter drain piston valve 126 the input of which is connected to the left filter output tee 80 in addition to the left manifold input line 82. Likewise, filter drain tee 124 allows flow into the main washer tank 37 from connected right filter drain piston valve 128 which is connected to the right filter output tee 104 in addition to the right manifold input line 106.

A complete cycle of the operation of the washer 10 will now be described in light of the various components described hereinabove. The washer begins with the washing fluid tank 50 and the rinse fluid tank 62 essentially full of containing cleaning fluid and rinse fluid, respectively, and the main washer tank essentially empty of fluid and all piston valves closed. The operator enters into the controller 42 whether (a) a single calibrator 12 or (b) a dual calibrator 14 or two single calibrators 12 is to be cleaned and positions the calibrator 12, 14 beneath the hood 22 and connects the hoses 28, 30 and opens ball valves 31 as described hereinabove, namely connects 28 if only washing a single calibrator 12 or connects both hoses 28 and hoses 30 if washing a dual calibrator 14 or two single calibrators 12. The controller 42 then opens cleaning fluid drop piston valve 60 allowing the cleaning fluid to drain from the cleaning fluid tank 50 down through cleaning fluid drop pipe 62 into the washer fluid input port 64 thereby filing the main washer tank 37. When the main washer tank fluid level gauge 41 in main washer tank 37 reaches a predetermined level, the controller 42 closes cleaning fluid drop piston valve 60. Controller 42 checks that hood 22 is closed and then engages lock 26.

Next, the controller 42 opens a relay to start left main pump 66 which pulls the cleaning fluid from main tank 37 through left pump input line 68. Left main pump 66 outputs the cleaning fluid past the closed pressure relief piston valve 70 to filter supply line 74 and then through left filter vacuum relief piston valve 76 which remains closed forcing the cleaning fluid to flow into and through left fluid filter 78 which filters particles of significant size from the fluid. The cleaning fluid flows through filter output tee 80 and through left manifold input line 82 and thereby into the left manifold 36. Left manifold 36 supplies the cleaning fluid through respective open ball valves 31 into left manifold hoses 30 connected to vacuum ports 13 of the calibrator 12, 14 and through an open ball valve 31 connected to the exterior spray line 32 supplying nozzles 33 thereby spraying the exterior of the calibrator 12, 14. The cleaning fluid flows out of the nozzles 33 and out of the vacuum slots and out of the profile openings in the ends of calibrator 12, 14 and drains back into the main washer tank 37.

If the operator has indicated that washer 10 will be cleaning a dual calibrator 14 or two single calibrators 12, then controller 42 will start the right main pump 90 in addition to the left main pump 66. Similarly, right main pump 90 outputs the cleaning fluid past the closed pressure relief piston valve 94 to filter supply line 98 and then through right filter vacuum relief piston valve 100 which remains closed forcing the cleaning fluid to flow into and through right fluid filter 102 which filters particles of significant size from the cleaning fluid. The cleaning fluid flows through right filter output tee 104 and through right manifold input line 106 and thereby into the right manifold 38. Right manifold 38 supplies the cleaning fluid through respective open ball valves 31 into right manifold hoses 28 connected to vacuum ports 13 of the calibrator 14 and through an open ball valve 31 connected to the exterior spray line 32 jointly with left main pump 66 supplying nozzles 33 thereby spraying the exterior of the calibrator 14. The cleaning fluid flows out of the nozzles 33 and out of the vacuum slots and then out of the ends of calibrator 14 and drains back into the main washer tank 37. The left main pump and as required for a dual calibrator 14 or two single calibrators 12, the right main pump, will be stopped by the controller 42 after a predetermined period of time completing the cleaning portion of the cycle.

Next the washer 10 will return the cleaning fluid to the cleaning fluid tank 50. First, the controller 42 will open the right filter vacuum relief piston valve 100, the left filter vacuum relief piston valve 76, the left filter drain piston valve 126, the right filter drain piston valve 128 (if running a dual calibrator 14 or two single calibrators 12), and the cleaning fluid return piston valve 114 and will start the transfer pump 108. Transfer pump 108 will then pull the cleaning fluid from the main washer tank 37 through the lower transfer pump junction 112 which pulls from drain line 122 which connects to the bottom of main washer tank 37. Since the left filter vacuum relief piston valve 76 is open, the filter drain tee 124 drains from the left fluid filter 78 into the main washer tank 37 since filter 78 is higher in elevation than bottom of main washer tank 37 that is being pumped out by transfer pump 108 through drain line 122. Likewise, since the right filter vacuum relief piston valve 100 and the right filter drain piston valve 128 are open, the filter drain tee 124 drains from the right fluid filter 102 into the main washer tank 37 that is being pumped out by transfer pump 108 through drain line 122 from lower transfer pump junction 112. Also, since the left filter vacuum relief piston valve 76 is open and left main pump 66 is off, the cleaning fluid in filter supply line 74 and left main pump 66 will drain into main washer tank 37 through left pump input line 68. Likewise, since the right filter vacuum relief piston valve 100 is open and right main pump 90 is off, the cleaning fluid in filter supply line 98 and right main pump 90 will drain into main washer tank 37 through right pump input line 92.

Transfer pump 108 pumps fluid to the upper transfer pump junction 110 from the lower transfer pump junction 112 and up through the open cleaning fluid return piston valve 114 through cleaning fluid return line 116 and into the cleaning fluid tank 50. When the fluid level gauge 41 in main washer tank 37 reaches a predetermined level indicating that the tank is empty, the controller 42 stops transfer pump 108 and closes the right filter vacuum relief piston valve 100, the left filter vacuum relief piston valve 76, the left filter drain piston valve 126, the right filter drain piston valve 128 if running a dual calibrator 14 or two single calibrators 12, and the cleaning fluid return piston valve 114. Here, the main washer tank 37 and left and right main pumps 66, 90 and left and right fluid filters 78, 102 are essentially empty to limit the amount of cleaning fluid not returned to cleaning fluid tank 50.

Next, washer 10 performs the rinse portion of the cycle. Controller 42 opens rinse fluid drop piston valve 84 allowing the rinse fluid to drain from the rinse fluid tank 52 down through rinse fluid drop pipe 86 into the rinse fluid input port 88 thereby filing the main washer tank 37. When the main washer tank fluid level gauge 41 in main washer tank 37 reaches a predetermined level, the controller 42 closes rinse fluid drop piston valve 84. In an identical manner to the process described above for the washing fluid, the washer 10 pumps rinse fluid through the calibrator 12, 14 for a predetermined time. Washer 10 then returns the rinse fluid to the rinse fluid tank 52 in an identical manner as described for the cleaning fluid except that the cleaning fluid return valve 114 remains closed and instead the rinse fluid return valve 118 is opened.

It should be noted that the cleaning fluid tank 50 and the rinse fluid tank 52 include fluid level gauges that function as fluid level gauge 41 in the main washer tank 37. Controller 42 can be programmed remind the operator to add additional supply fluid to the respective tank 50, 52 when the level drops below a predetermined point. In addition, if the fluid level in main washer tank 37 drops below a predetermined point, controller 42 will open either the cleaning fluid or the rinse fluid drop piston valves 60, 84 allowing either cleaning fluid or rinse fluid to drain from the cleaning or rinse fluid tank 50, 52 filing the main washer tank 37 with cleaning or rinse fluid depending on which is currently in use. Thus, spray or vapor loss of fluid during a cleaning or rinse cycle will not cause too little fluid to remain in main washer tank 37 for proper use by right and left main pumps 66, 90. In addition, washer fluid tank 50, rinse fluid 52 and main washer tank 37 include self contained heater coils indicated at reference numerals 130, 132 and 134, respectively.

The preferred cleaning fluid is LF2100 liquid low-foam cleaner diluted in water. LF2100 is available from International Products Corporation of Burlington, N.J. Aqua Mate 86 parts wash diluted in water, available from Chemlogis of Tualatin, Oreg. will also work with the machinery and process herein described. Self-contained heater coils 130, 132 and 134 are preferably set at 180° F. keeping the cleaning and rinse fluids at approximately that temperature as 180 F. is significantly higher than the wax transition phase temperature that is typically a major component of the residue deposited in a calibrator. The pressure relief piston valves 70, 94 are preferably set at 90 psi as such pressures do not damage the components of the washer 10 or of the calibrators 12, 14. Main pumps 66, 90 are 15 horsepower as this flowed enough fluid through ¾ inch or 1 inch vacuum ports 13 below a pressure of approximately 90 psi to allow a cycle time of 15 minutes of pumping cleaning fluid and 5 minutes of pumping rinse fluid. This cycle time would allow cleaning of four to six calibrators 12 per man-hour where as the prior art method typically would require approximately one calibrator per man-hour. The cycle time and amount of cleaner can be optimized for particular calibrators and/or extrusions processes to achieve the maximum throughput while allowing the proper cleaning of calibrators 12, 14.

We claim:

1. A calibrator cleaning machine for cleaning a profile extrusion calibrator, comprising:
a cleaning fluid and a cleaning fluid tank,
a rinse fluid and rinse fluid tank, and
a means for pumping the cleaning fluid into at least one vacuum port in a calibrator and out of at least one vacuum slot of the calibrator and then pumping the rinse fluid into the at least one vacuum port and out at least one vacuum slot of the calibrator, where the calibrator is remains fully assembled comprising at least one vacuum port and at least one vacuum slot on the interior operative surface of the calibrator.

2. The calibrator cleaning machine of claim 1, wherein, the means for pumping the cleaning fluid into at least one vacuum port in a calibrator and out of at least one vacuum slot of the calibrator and then pumping the rinse fluid into the at least one vacuum port and out at least one vacuum slot of the calibrator, comprises
a main washer tank,
a transfer pump for transferring the cleaning fluid from the cleaning fluid tank to the main washer tank and from the main washer tank to the cleaning fluid tank and for transferring the rinse fluid from the rinse fluid tank to the main washer tank and from the main washer tank to the rinse fluid tank, and
a main pump for pumping either the washing fluid or the rinse fluid from the main washer tank through the at least one vacuum port in the calibrator and out of the at least one vacuum slot of the calibrator.

3. A method for cleaning a profile extrusion calibrator, comprising,
pumping of a cleaning fluid into at least one vacuum port in the calibrator and out of at least one vacuum slot of the calibrator, then
pumping a rinse fluid into at least one vacuum port in the calibrator and out of at least one vacuum slot of the calibrator, where the calibrator is remains fully assembled comprising at least one vacuum port and at least one vacuum slot on the interior operative surface of the calibrator.

4. The method of claim 3, wherein the pumping of the cleaning fluid into at least one vacuum port in the calibrator and out of at least one vacuum slot of the calibrator comprises,
transferring the cleaning fluid into a main washer tank before pumping the cleaning fluid into at least one vacuum port in the calibrator and out of at least one vacuum slot of the calibrator,
pumping the cleaning fluid into the at least one vacuum port in the calibrator and out of the at least one vacuum slot of the calibrator, and
transferring the cleaning fluid out of the main washer tank, and
wherein the pumping of the rinse fluid into at least one vacuum port in the calibrator and out of at least one vacuum slot of the calibrator comprises,
transferring the rinse fluid into the main washer tank before pumping the rinse fluid into at least one vacuum port in the calibrator and out of at least one vacuum slot of the calibrator,
pumping the rinse fluid into at least one vacuum port in the calibrator and out of at least one vacuum slot of the calibrator, and
transferring the cleaning fluid out of the main washer tank.

5. The method of claim 4, wherein,
transferring the cleaning fluid into a main washer tank comprises pumping the cleaning fluid from a cleaning fluid tank into the main washer tank with a transfer pump, and
transferring the cleaning fluid out of the main washer tank comprises pumping the cleaning fluid from the washer fluid tank into the cleaning fluid tank with the transfer pump, and
transferring the rinse fluid into the main washer tank comprises pumping the rinse fluid from a rinse fluid tank into the main washer tank with the transfer pump, and
transferring the rinse fluid out of the main washer tank comprises pumping the rinse fluid from the washer fluid tank into the rinse fluid tank with the transfer pump.
